(19) United States
(12) Patent Application Publication
(10) Pub. No.: US 2023/0386493 A1
(43) Pub. Date: Nov. 30, 2023

(54) NOISE SUPPRESSION DEVICE, NOISE SUPPRESSION METHOD, AND STORAGE MEDIUM STORING NOISE SUPPRESSION PROGRAM

(71) Applicant: Mitsubishi Electric Corporation, Tokyo (JP)

(72) Inventor: Toshiyuki HANAZAWA, Tokyo (JP)

(73) Assignee: Mitsubishi Electric Corporation, Tokyo (JP)

(21) Appl. No.: 18/233,476

(22) Filed: Aug. 14, 2023

Related U.S. Application Data
(63) Continuation of application No. PCT/JP2021/009490, filed on Mar. 10, 2021.

(51) Int. Cl. G10L 21/0224; G10L 25/21; G10L 25/18

(52) U.S. Cl. CPC G10L 21/0224; G10L 25/18; G10L 25/21

(57) ABSTRACT

A noise suppression device includes processing circuitry to generate post-noise suppression data by performing a noise suppression process on input data; to determine a weighting coefficient based on the input data in a predetermined section in a time series and the post-noise suppression data in the predetermined section; and to generate output data by performing weighted addition on the input data and the post-noise suppression data by using values based on the weighting coefficient as weights.

### CROSS-REFERENCE TO RELATED APPLICATION

This application is a continuation application of International Application No. PCT/JP2021/009490 having an international filing date of Mar. 10, 2021.

### BACKGROUND OF THE INVENTION

### 1. Field of the Invention

The present disclosure relates to a noise suppression device, a noise suppression method and a storage medium storing a noise suppression program.

### 2. Description of the Related Art

The Weiner method is known as a method for reducing a noise component included in a signal of sound in which disturbing noise (hereinafter referred to also as “noise”) has mixed into voice (hereinafter referred to also as “speech”). With this method, the S/N (signal-to-noise) ratio is improved, whereas a speech component deteriorates. Therefore, there has been proposed a method that inhibits the deterioration of the speech component while improving the S/N ratio by executing a noise reduction process corresponding to the S/N ratio (see Non-patent Reference 1, for example).

Non-patent Reference 1: Junko Sasaki and another, “Study on the Effective Ratio of Adding Original Source Signal in Low-distortion Noise Reduction Method Using Masking Effect”, Proceedings of the Autumn Meeting of the Acoustical Society of Japan, pp. 503-504, September 1998.

However, in a noisy environment, the speech as a target of recognition is buried in the noise and an accuracy of measurement of the S/N ratio decreases. Thus, there is a problem in that inhibition of the noise component and inhibition of deterioration of the speech component are not executed appropriately.

### SUMMARY OF THE INVENTION

An object of the present disclosure, which has been made to resolve the above-described problem, is to provide a noise suppression device, a noise suppression method and a noise suppression program that make it possible to appropriately execute inhibition of the noise component and inhibition of deterioration of the speech component.

### Means for Solving the Problem

A noise suppression device in the present disclosure includes a noise suppression unit to generate post-noise suppression data by performing a noise suppression process on input data, a weighting coefficient calculation unit to determine a weighting coefficient based on the input data in a predetermined section in a time series and the post-noise suppression data in the predetermined section, and a weighted sum unit to generate output data by performing weighted addition on the input data and the post-noise suppression data by using values based on the weighting coefficient as weights.

Another noise suppression device in the present disclosure includes a noise suppression unit to generate post-noise suppression data by performing a noise suppression process on input data, a weighting coefficient calculation unit to segment data in a whole section of the input data into a plurality of predetermined short sections in a time series and determines a weighting coefficient in each of the plurality of short sections based on the input data in the plurality of short sections and the post-noise suppression data in the plurality of short sections, and a weighted sum unit to generate output data by performing weighted addition on the input data and the post-noise suppression data by using values based on the weighting coefficient as weights in each of the plurality of short sections.

According to the present disclosure, the inhibition of the noise component in the input data and the inhibition of the deterioration of the speech component in the input data can be executed appropriately.

### BRIEF DESCRIPTION OF THE DRAWINGS

The present invention will become more fully understood from the detailed description given hereinbelow and the accompanying drawings which are given by way of illustration only, and thus are not limitative of the present invention, and wherein:

FIG. 1 is a diagram showing an example of a hardware configuration of a noise suppression device according to first to third embodiments;

FIG. 2 is a functional block diagram schematically showing a configuration of the noise suppression device according to the first embodiment;

FIG. 3 is a flowchart showing an operation of the noise suppression device according to the first embodiment;

FIG. 4 is a functional block diagram schematically showing a configuration of a noise suppression device according to a second embodiment;

FIG. 5 is a diagram showing an example of a weighting coefficient table used in the noise suppression device according to the second embodiment;

FIG. 6 is a flowchart showing an operation of the noise suppression device according to the second embodiment;

FIG. 7 is a functional block diagram schematically showing a configuration of a noise suppression device according to a third embodiment;

FIG. 8 is a flowchart showing an operation of the noise suppression device according to the third embodiment; and

FIG. 9 is a flowchart showing a method of calculating weighting coefficients in the noise suppression device according to the third embodiment.

### DETAILED DESCRIPTION OF THE INVENTION

A noise suppression device, a noise suppression method and a noise suppression program according to each embodiment will be described below with reference to the drawings. The following embodiments are just examples and it is possible to appropriately combine embodiments and appropriately modify each embodiment.

### First Embodiment

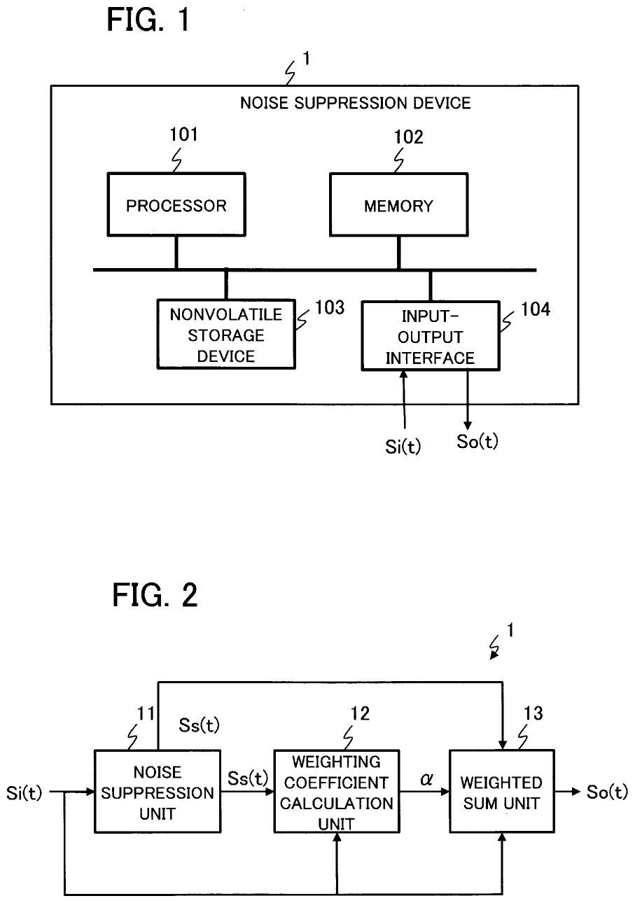

FIG. 1 shows an example of a hardware configuration of a noise suppression device 1 according to a first embodiment. The noise suppression device 1 is a device capable of executing a noise suppression method according to the first embodiment. The noise suppression device 1 is, for example, a computer that executes a noise suppression program according to the first embodiment. As shown in FIG. 1, the noise suppression device 1 includes a processor 101 as an information processing unit that processes information, a memory 102 as a volatile storage device, a nonvolatile storage device 103 as a storage unit that stores information, and an input-output interface 104 used for executing data transmission/reception to/from an external device. The nonvolatile storage device 103 may also be a part of a different device capable of communicating with the noise suppression device 1 via a network. The noise suppression program can be acquired by means of downloading performed via the network or loading from a record medium or a storage medium (i.e., a non-transitory computer-readable storage medium storing the noise suppression program) such as an optical disc storing information. The hardware configuration shown in FIG. 1 is applicable also to noise suppression devices 2 and 3 according to second and third embodiments which will be described later.

The processor 101 controls the operation of the whole of the noise suppression device 1. The processor 101 is a CPU (Central Processing Unit), an FPGA (Field Programmable Gate Array) or the like, for example. The noise suppression device 1 may also be implemented by processing circuitry. Further, the noise suppression device 1 may also be implemented by software, firmware, or a combination of software and firmware.

The memory 102 is main storage of the noise suppression device 1. The memory 102 is a RAM (Random Access Memory), for example. The nonvolatile storage device 103 is auxiliary storage of the noise suppression device 1. The nonvolatile storage device 103 is an HDD (Hard Disk Drive) or an SSD (Solid State Drive), for example. The input-output interface 104 executes inputting of input data Si(t) and outputting of, output data So(t). The input data Si(t) is, for example, data inputted from a microphone and converted to digital data. The input-output interface 104 is used for reception of an operation signal based on a user operation performed by using a user operation unit (e.g., a speech input start button, a keyboard, a mouse, a touch panel or the like), communication with a different device, and so forth. The character t is an index indicating a position in a time series. A greater value of t indicates a later time on a time axis.

FIG. 2 is a functional block diagram schematically showing the configuration of the noise suppression device 1 according to the first embodiment. As shown in FIG. 2, the noise suppression device 1 includes a noise suppression unit 11, a weighting coefficient calculation unit 12 and a weighted sum unit 13.

The input data Si(t) to the noise suppression device 1 is PCM (pulse code modulation) data obtained by performing A/D (analog-to-digital) conversion on a signal in which a noise component is superimposed on a speech component as the target of recognition. Here, t=1, 2, . . . , T. The character t represents an integer as the index indicating a position in a time series. The character T represents an integer indicating a duration of the input data Si(t).

The output data So(t) is data in which the noise component in the input data Si(t) has been suppressed. The output data So(t) is transmitted to a publicly known speech recognition device, for example. Here, the meanings of t and T are as already explained.

The noise suppression unit 11 receives the input data Si(t) and outputs PCM data obtained by suppressing the noise component in the input data Si(t), namely, post-noise suppression data Ss(t) as data after undergoing a noise suppression process. Here, the meanings of t and T are as already explained. In the post-noise suppression data Ss(t), there can occur a phenomenon such as an insufficient suppression amount of the noise component, distortion of the speech component as a component of voice as the target of recognition, or disappearance of the speech component.

The noise suppression unit 11 can employ any noise suppression scheme. In the first embodiment, the noise suppression unit 11 executes the noise suppression process by using a neural network (NN). The noise suppression unit 11 learns the neural network before executing the noise suppression process. The learning can be executed by means of, for example, the error back propagation method by using PCM data of sound in which noise is superimposed on voice as input data and using PCM data in which no noise is superimposed on voice as training data.

The weighting coefficient calculation unit 12 determines (i.e., calculates) a weighting coefficient a based on the input data Si(t) in a predetermined section in the time series and the post-noise suppression data Ss(t) in the predetermined section.

The weighted sum unit 13 generates the output data So(t) by performing weighted addition on the input data Si(t) and the post-noise suppression data Ss(t) by using values based on the weighting coefficient α as weights.

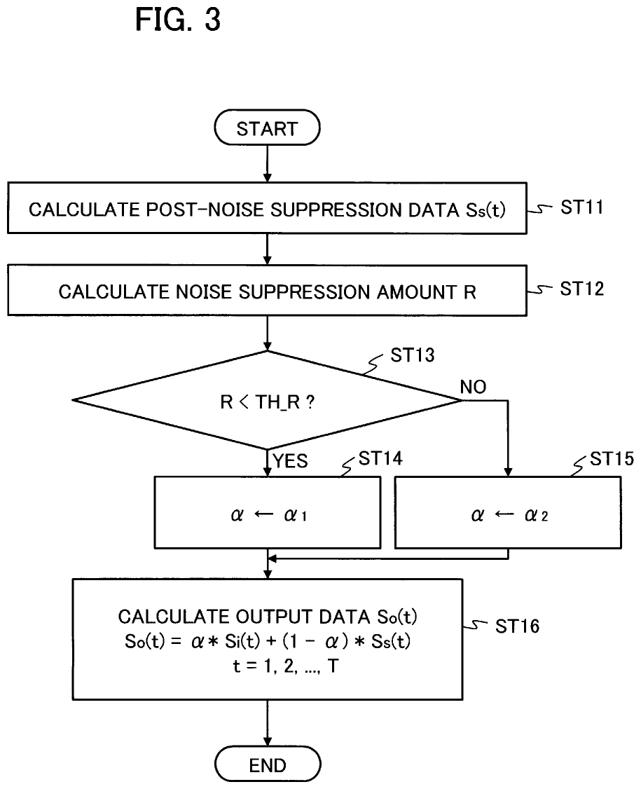

FIG. 3 is a flowchart showing the operation of the noise suppression device 1. In step ST11 in FIG. 3, the reception of the input data Si(t) by the noise suppression device 1 is started, and when the input data Si(t) has been inputted to the noise suppression device 1, the noise suppression unit 11 performs the noise suppression process on the input data Si(t) and thereby generates the post-noise suppression data Ss(t).

Subsequently, in step ST12 in FIG. 3, the weighting coefficient calculation unit 12 receives the input data Si(t) as the data before the noise suppression and the post-noise suppression data Ss(t) and calculates power P1 of the input data Si(t) and power P2 of the post-noise suppression data Ss(t) in a predetermined section (e.g., section for a short time such as 0.5 seconds) from a front end of the input data Si(t) and the post-noise suppression data Ss(t). The data in the predetermined section is considered not to include the speech component as the target of recognition and to include only the noise component. This is because it is highly unlikely that speech is started immediately after the startup of the noise suppression device 1 (e.g., immediately after a speech input start operation is performed). In other words, that is because the speaker who utters speech as the target of recognition (i.e., user) does not utter voice at least when inhaling air since the user performs the speech input start operation on the device, inhales air and thereafter utters voice while breathing out from the lungs. Thus, the predetermined section at the start of the speech input is normally a section not including voice of the speaker and including only noise, namely, a noise section. In the following description, a reference character E is assigned to the noise section.

Incidentally, the noise section E is not limited to the 0.5-second section from the front end of the input data but can also be a section for different duration such as a 1-second section or a 0.75-second section. However, when the noise section E is excessively long, the possibility of mixing in of the speech component increases whereas the reliability of the weighting coefficient α increases. When the noise section E is excessively short, the reliability of the weighting coefficient α decreases even though the possibility of mixing in of the speech component is low. Therefore, the noise section E is desired to be set appropriately depending on the use environment, the user's request, or the like.

Subsequently, by using the power P1 of the input data Si(t) in the noise section E and the power P2 of the post-noise suppression data Ss(t) in the noise section E, the weighting coefficient calculation unit 12 calculates a noise suppression amount R as a decibel value of a ratio between the power P1 and the power P2. Namely, the weighting coefficient calculation unit 12 calculates the noise suppression amount R based on the ratio between the power P1 of the input data Si(t) in the noise section E and the power of the post-noise suppression data Ss(t) in the noise section E, and determines the value of the weighting coefficient α based on the noise suppression amount R. A calculation formula for the noise suppression amount R is the following expression (1), for example:

$$R = 10 * {log}_{10} \frac{P 1}{P 2} . \qquad ( 1 )$$

The noise suppression amount R calculated according to the expression (1) indicates the level of the noise suppression by the noise suppression unit 11 between the input data Si(t) in the noise section E and the post-noise suppression data Ss(t) in the noise section E. The level of the noise suppression by the noise suppression unit 11 is higher with the increase in the noise suppression amount R.

In steps ST13, ST14 and ST15 in FIG. 3, the weighting coefficient calculation unit 12 determines the value of the weighting coefficient α based on the calculated noise suppression amount R. Namely, the weighting coefficient calculation unit 12 compares the calculated noise suppression amount R with a predetermined threshold value TH_R and determines the value of the weighting coefficient α based on the result of the comparison.

Specifically, when the noise suppression amount R is less than the threshold value TH_R (YES in the step ST13), the weighting coefficient calculation unit 12 outputs a predetermined value α₁ as the weighting coefficient α in the step ST14. In contrast, when the noise suppression amount R is greater than or equal to the threshold value TH_R (NO in the step ST13), the weighting coefficient calculation unit 12 outputs a predetermined value α₂ as the weighting coefficient α in the step ST15. The values α₁ and α₂ are constants greater than or equal to 0 and less than or equal to 1 and satisfying α₁>α₂. Incidentally, the values α₁ and α₂ have been previously set and stored in the nonvolatile storage device 103 together with the threshold value TH_R. For example, TH_R=3, α₁=0.5, and α₂=0.2.

The weighting coefficient calculation unit 12 calculating the weighting coefficient α as above reduces ill effects of the noise suppression by increasing the weighting coefficient α for the input data Si(t) in a noise environment in which it can be considered that the effect of the noise suppression is slight due to a small noise suppression amount R and ill effects of distortion or disappearance of speech can increase adversely. In contrast, when the noise suppression amount R is large, the effect of the noise suppression is considered to be great, and thus the weighting coefficient calculation unit 12 is capable of reducing the ill effects of the distortion or the disappearance of speech without excessively reducing the effect of the noise suppression by decreasing the weighting coefficient α for the input data Si(t) and relatively increasing the weighting on the post-noise suppression data Ss(t).

Subsequently, in step ST16 in FIG. 3, the weighted sum unit 13 calculates and outputs the output data So(t) based on the input data Si(t), the post-noise suppression data Ss(t) and the weighting coefficient α by using the following expression (2):

So(t)=α*Si(t)+(1−α)*Ss(t) (t=0, 1, 2, . . . , T) (2).

As described above, with the noise suppression device 1 or the noise suppression method according to the first embodiment, in a noise environment in which the noise suppression amount R is small, the weighting coefficient α to multiply the input data Si(t) is increased and the coefficient (1−α) representing the noise suppression effect is decreased. In contrast, in a noise environment in which the noise suppression amount R is large, the weighting coefficient α to multiply the input data Si(t) is decreased and the coefficient (1−α) representing the noise suppression effect is increased. By such a process, speech data with less ill effects of the distortion or the disappearance of speech as the target of recognition can be outputted as the output data So(t) without excessively reducing the noise suppression effect. Namely, in the first embodiment, the inhibition of the noise component in the input data Si(t) and the inhibition of the deterioration of the speech component can be executed appropriately.

Further, with the noise suppression device 1 or the noise suppression method according to the first embodiment, the value of the weighting coefficient α is determined by using the input data Si(t) in the noise section E as a short time from the time of the speech input start of the noise suppression device 1 and the post-noise suppression data Ss(t) in the noise section E. Therefore, it is unnecessary to use the speech power, which is difficult to measure in a noise environment, as in a technology of determining the weighting coefficient α by using the S/N ratio of the input data. Accordingly, calculation accuracy of the weighting coefficient α can be improved, and the inhibition of the noise component in the input data Si(t) and the inhibition of the deterioration of the speech component can be executed appropriately. Further, the weighting coefficient α can be determined with no delay relative to the input data Si(t).

### Second Embodiment

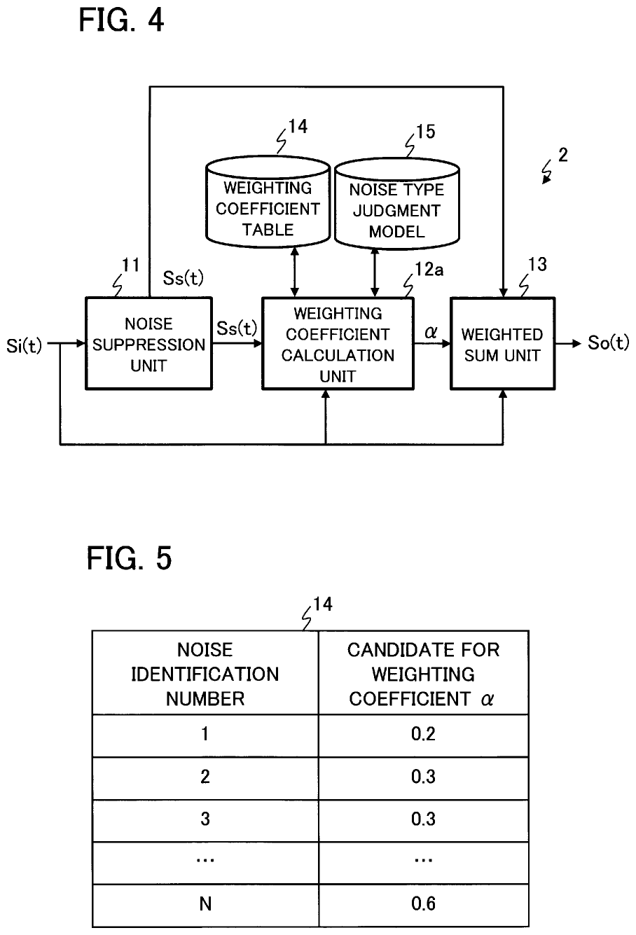

FIG. 4 is a block diagram schematically showing the configuration of a noise suppression device 2 according to a second embodiment. In FIG. 4, each component identical or corresponding to a component shown in FIG. 2 is assigned the same reference character as in FIG. 2. As shown in FIG. 4, the noise suppression device 2 includes the noise suppression unit 11, a weighting coefficient calculation unit 12a, the weighted sum unit 13, a weighting coefficient table 14 and a noise type judgment model 15. The hardware configuration of the noise suppression device 2 is the same as that shown in FIG. 1. The weighting coefficient table 14 and the noise type judgment model 15 are previously obtained by means of learning and stored in the nonvolatile storage device 103, for example.

The weighting coefficient table 14 holds predetermined weighting coefficient candidates while associating them with noise identification numbers assigned respectively to a plurality of types of noise. The noise type judgment model 15 is used for judging which of the plurality of types of noise in the weighting coefficient table 14 corresponds to the noise component included in the input data based on a spectral feature value of the input data. By using the noise type judgment model 15, the weighting coefficient calculation unit 12a calculates noise, as one of the plurality of types of noise, being the most similar to the data in the aforementioned predetermined section (E) in the input data, and outputs a weighting coefficient candidate associated with the noise identification number of the calculated noise from the weighting coefficient table 14 as the weighting coefficient α.

FIG. 5 is a diagram showing an example of the weighting coefficient table 14. In the weighting coefficient table 14, in regard to each of the plurality of types of noise to which the noise identification numbers have previously been assigned, a candidate for the most suitable weighting coefficient α (i.e., weighting coefficient candidate) previously determined while being associated with a noise identification number is held. The weighting coefficient table 14 is generated preliminarily by using a plurality of types of noise data and speech data for evaluation.

Specifically, noise superimposition speech data, as superimposition of one of the plurality of types of noise data on the speech data for evaluation, is generated and inputted to the noise suppression unit 11, and data outputted from the noise suppression unit 11 is the post-noise suppression data. This process is executed for each of the plurality of types of noise data and a plurality of pieces of post-noise suppression data are obtained.

Subsequently, a plurality of types of weighting coefficients are set, and recognition rate evaluation data is generated by taking a weighted average of the noise superimposition speech data and the post-noise suppression data by using each weighting coefficient.

Subsequently, in regard to each of the plurality of weighting coefficients, a speech recognition test is performed on the recognition rate evaluation data, and a weighting coefficient yielding the highest recognition rate is held in the weighting coefficient table 14 together with the noise identification number of the noise data. Incidentally, the speech recognition test is performed by a speech recognition engine that recognizes speech. The speech recognition engine recognizes a human's speech and converts the speech to text. While it is desirable to perform the speech recognition test by using a speech recognition engine used in combination with the noise suppression device 2, a publicly known speech recognition engine can be used.

The noise type judgment model 15 is a model used for judging which one of the plurality of types of noise to which the noise identification number are previously assigned is the most similar to the noise component included in the input data Si(t). The noise type judgment model 15 is generated preliminarily by using the plurality of types of noise data to which the noise identification numbers are previously assigned.

Specifically, the spectral feature values of the plurality of types of noise data to which the noise identification numbers are previously assigned are calculated, and the noise type judgment model 15 is generated by using the calculated spectral feature values. The noise type judgment model 15 can be constructed with a publicly known pattern recognition model such as a neural network or GMM (Gaussian Mixture Model). In the second embodiment, a neural network is used as the noise type judgment model 15. The number of output units of the neural network is the number of types of the plurality of types of noise to which the noise identification numbers are previously assigned. Each output unit has been associated with a noise identification number. Further, in the second embodiment, a Mel-filterbank feature value is used as the spectral feature value.

Before executing the noise suppression, it is necessary to learn the neural network being the noise type judgment model 15. The learning can be carried out by means of the error back propagation method by using the Mel-filterbank feature value as input data and using data in which the output value of the output unit corresponding to the noise identification number of the input data is set at 1 and the output values of the other output units are set at 0 as the training data. By this learning, the noise type judgment model 15 is learned so that the output value of the output unit having a corresponding noise identification number becomes higher than the output values of the other output units when the Mel-filterbank feature value of noise is inputted. Therefore, in the judgment of the type of noise, the noise identification number associated with the output unit outputting the highest value in response to the inputted Mel-filterbank feature value is obtained as the result of the judgment.

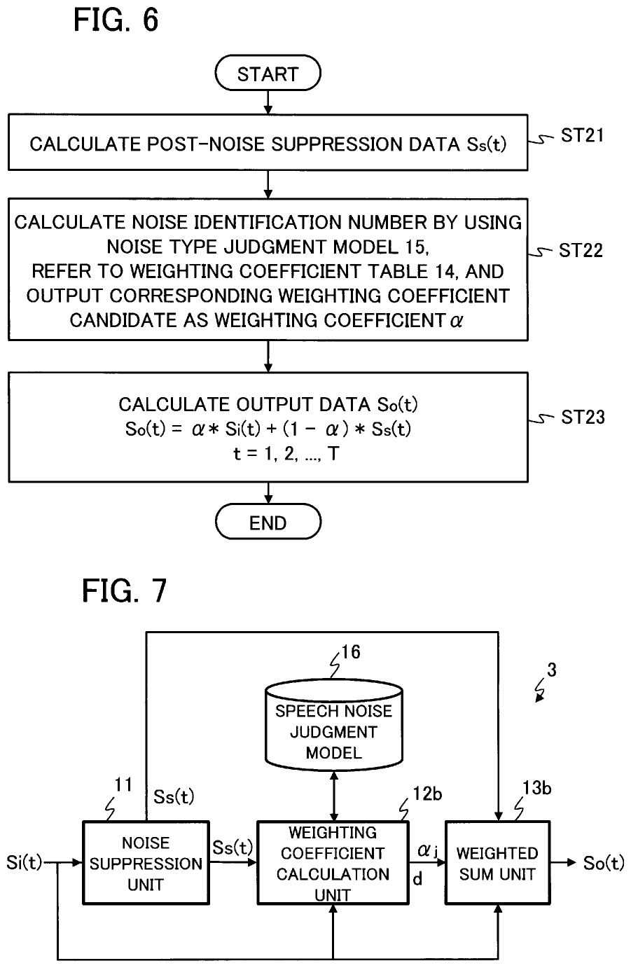

FIG. 6 is a flowchart showing the operation of the noise suppression device 2. When the input data Si(t) is inputted to the noise suppression device 2, the noise suppression unit 11 in step ST21 in FIG. 6 performs the noise suppression process on the input data Si(t) and thereby outputs the post-noise suppression data Ss(t). In the second embodiment, t=1, 2, . . . , T. The characters t and T are the same as those in the first embodiment.

Subsequently, in step ST22 in FIG. 6, the weighting coefficient calculation unit 12a receiving the input data Si(t) calculates the Mel-filterbank feature value as the spectral feature value of the input data Si(t) in regard to the noise section E (e.g., section for a short time such as 0.5 seconds) as the predetermined section from the front end of the input data Si(t), and obtains the noise identification number by using the noise type judgment model 15. Namely, the weighting coefficient calculation unit 12a inputs the Mel-filterbank feature value to the noise type judgment model 15 and obtains the noise identification number associated with the output unit outputting the highest value among the output units of the noise type judgment model 15. Then, the weighting coefficient calculation unit 12a refers to the weighting coefficient table 14 and outputs the weighting coefficient candidate corresponding to the noise identification number as the weighting coefficient α.

Subsequently, in step ST23 in FIG. 6, the weighted sum unit 13 receives the input data Si(t), the post-noise suppression data Ss(t) as the output of the noise suppression unit 11, and the weighting coefficient α, and calculates and outputs the output data So(t) according to the aforementioned expression (2). The operation of the weighted sum unit 13 is the same as that in the first embodiment.

As described above, with the noise suppression device 2 or the noise suppression method according to the second embodiment, the weighting coefficient calculation unit 12a judges the type of noise included in the input data Si(t) by using the noise type judgment model 15, and based on the result of the judgment, determines (i.e., acquires) a weighting coefficient candidate that is appropriate in the noise environment from the weighting coefficient table 14 as the weighting coefficient α. Accordingly, this embodiment is advantageous in that the noise suppression performance can be improved.

Incidentally, except for the above-described features, the second embodiment is the same as the first embodiment.

### Third Embodiment

FIG. 7 is a functional block diagram schematically showing the configuration of a noise suppression device 3 according to a third embodiment. In FIG. 7, each component identical or corresponding to a component shown in FIG. 2 is assigned the same reference character as in FIG. 2. As shown in FIG. 7, the noise suppression device 3 includes the noise suppression unit 11, a weighting coefficient calculation unit 12b, a weighted sum unit 13b and a speech noise judgment model 16. The hardware configuration of the noise suppression device 3 is the same as that shown in FIG. 1. The speech noise judgment model 16 is stored in the nonvolatile storage device 103, for example.

The speech noise judgment model 16 is a model for judging whether or not speech is included in data included in the input data Si(t). The speech noise judgment model 16 is generated preliminarily by using speech data and a plurality of types of noise data.

Specifically, the spectral feature values are calculated in regard to the plurality of types of noise data, the speech data, and data obtained by superimposing a plurality of types of noise on the speech data, and the speech noise judgment model 16 is generated by using the calculated spectral feature values. The speech noise judgment model 16 can be constructed with any pattern recognition model such as a neural network or GMM. In the third embodiment, a neural network is used for generating the speech noise judgment model 16. For example, the number of output units of the neural network is set at two and the output units are associated with speech and noise. As the spectral feature value, the Mel-filterbank feature value is used, for example. Before executing the noise suppression, it is necessary to learn the neural network being the speech noise judgment model 16. The learning can be carried out by means of the error back propagation method by using the Mel-filterbank feature value as the input data and using data in which the output value of the output unit corresponding to speech is set at 1 and the output value of the output unit corresponding to noise is set at 0 (when the input data is data including speech, namely, speech data or speech data with a plurality of types of noise superimposed thereon) or data in which the output value of the output unit corresponding to speech is set at 0 and the output value of the output unit corresponding to noise is set at 1 (when the input data is noise data) as the training data. By this learning, the speech noise judgment model 16 is learned so that the output value of the output unit corresponding to speech becomes high when the Mel-filterbank feature value of speech data or speech data with noise superimposed thereon is inputted and the output value of the output unit corresponding to noise becomes high when the Mel-filterbank feature value of noise data is inputted. Therefore, in the judgment on whether the input data includes speech or not, the weighting coefficient calculation unit 12b is capable of judging that the input data is data including speech if the output unit outputting the highest value in response to the inputted Mel-filterbank feature value is an output unit associated with speech and judging that the input data is noise if the output unit outputting the highest value in response to the inputted Mel-filterbank feature value is an output unit associated with noise.

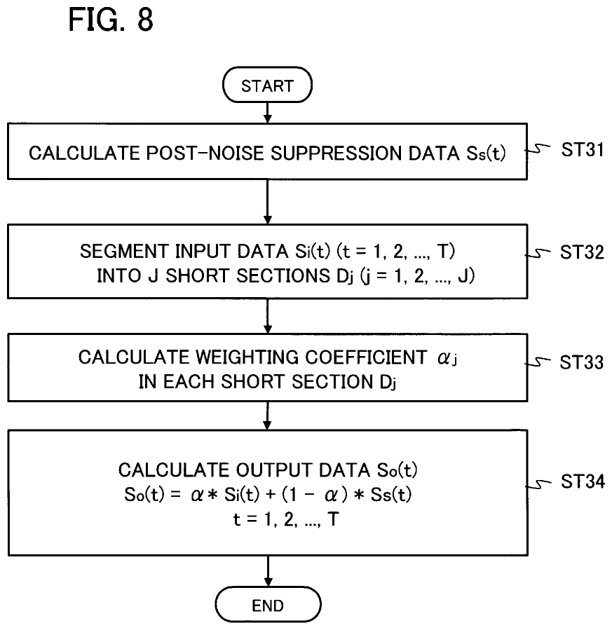

FIG. 8 is a flowchart showing the operation of the noise suppression device 3. When the input data Si(t) is inputted to the noise suppression device 3, the noise suppression unit 11 in step ST31 in FIG. 8 performs the noise suppression process on the input data Si(t) and thereby outputs the post-noise suppression data Ss(t). In the third embodiment, t=1, 2, . . . , T. The characters t and T are the same as those in the first embodiment.

Subsequently, in step ST32 in FIG. 8, the weighting coefficient calculation unit 12b receives the input data Si(t) and the post-noise suppression data Ss(t) and segments each of the sections t=1, 2, . . . , T of the input data Si(t) into short sections Dⱼ (j=1, 2, . . . , J) each having duration d equal to a predetermined short time. Namely, the section t=1, 2, . . . , T of the input data Si(t) is segmented into short sections D₁, D₂, D₃, . . . , D_{J}. Specifically, one short section Dⱼ includes a certain number of pieces of data corresponding to the duration d, and the total of the J short sections D₁-D_{J} includes T pieces of data. By expressing the fact that one short section Dⱼ includes the certain number of pieces of data corresponding to d as

Dⱼ={t=(j−1)*d+1, (j−1)*d+2, . . . , j*d},

D₁ to D_{J} are expressed as follows:

D₁={t1, 2, . . . , d}

D₂={t=d+1, d+2, . . . , 2d}

D₃={t=2d+1, 2d+2, . . . , 3d}

. . .

Dⱼ={t=(j−1)*d+1, (j−1)*d+2, . . . , j*d}

. . .

D_{J}={t=(J−1)*d+1, (J−1)*d+2, . . . , T}.

Here, J is an integer obtained by using the following expression (3). In the expression (3), the symbol [ ] represents an operator that rounds off the numerical value in the symbol to an integer by removing digits of the numerical value in the symbol after the decimal point.

$$J = [ \frac{T}{d} ] + 1. \qquad ( 3 )$$

Then, in step ST33, the weighting coefficient αⱼ is calculated for each short section Dⱼ and is outputted together with the value of the duration d as the short time. Incidentally, a concrete method of calculating the weighting coefficient αⱼ will be described later.

Subsequently, in step ST34, the weighted sum unit 13b obtains and outputs the output data So(t) according to the following expression (4) by using the input data Si(t), the post-noise suppression data Ss(t), the weighting coefficients αⱼ and the duration d of the short section as inputs:

So(t)=αⱼ*Si(t)+(1−αⱼ)*Ss(t) (t=0, 1, 2, . . . , T) (4).

Incidentally, in the expression (4), j is calculated according to the following expression (5). In the expression (5), the symbol [ ] represents an operator that rounds off the numerical value in the symbol to an integer by removing digits of the numerical value in the symbol after the decimal point.

$$j = [ \frac{t}{d + 1} ] + 1. \qquad ( 5 )$$

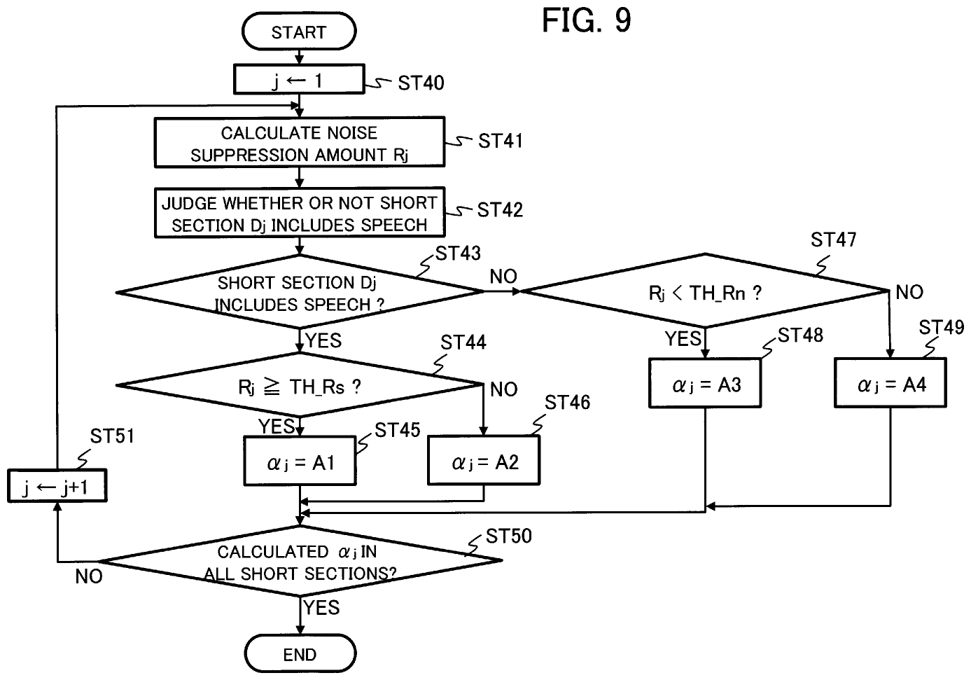

FIG. 9 is a flowchart showing a method of calculating the weighting coefficients αⱼ. First, in step ST40, the weighting coefficient calculation unit 12b sets the number j of the short section Dⱼ at j=1.

Subsequently, in step ST41, the weighting coefficient calculation unit 12b receives the input data

Si(t) (t=(j−1)*d+1, (j−1)*d+2, . . . , j*d)

and the post-noise suppression data

Ss(t) (t=(j−1)*d+1, (j−1)*d+2, . . . , j*d)

in the short section

Dⱼ={t=(j−1)*d+1, (j−1)*d+2, . . . , j*d},

calculates the power Piⱼ of the input data Si(t) in the short section Dⱼ and the power Psⱼ of the post-noise suppression data Ss(t) in the short section Dⱼ, and calculates the noise suppression amount Rⱼ as the decibel value of the ratio between the power Piⱼ and the power Psⱼ according to the following expression (6):

$${R}_{j} = 10 * {log}_{10} \frac{P {i}_{j}}{P {s}_{j}} . \qquad ( 6 )$$

Subsequently, in step ST42, the weighting coefficient calculation unit 12b calculates the Mel-filterbank feature value as the spectral feature value in regard to the input data

Si(t) (t=(j−1)*d+1, (j−1)*d+2, . . . , j*d)

in the short section

Dⱼ={t=(j−1)*d+1, (j−1)*d+2, . . . , j*d}

The weighting coefficient calculation unit 12b judges whether the Mel-filterbank feature value is that of speech data or that of noise data with superimposed noise by using the speech noise judgment model 16. Namely, the weighting coefficient calculation unit 12b inputs the Mel-filterbank feature value to the speech noise judgment model 16, and judges that the short section Dⱼ includes speech if the output unit outputting the highest value among the output units of the speech noise judgment model 16 is a unit associated with speech or judges that the short section Dⱼ is noise otherwise.

Subsequently, in step ST43, the weighting coefficient calculation unit 12b branches the process depending on whether the result of the judgment on the short section Dⱼ is “includes speech” or not. If the judgment result is “includes speech”, the weighting coefficient calculation unit 12b in step ST44 judges whether or not the noise suppression amount Rⱼ is greater than or equal to a predetermined threshold value TH_Rs, and if the noise suppression amount Rⱼ is greater than or equal to the threshold value TH_Rs (referred to also as a “first threshold value”), sets a predetermined value A1 (referred to also as a “first value”) as the weighting coefficient αⱼ in step ST45. In contrast, if the value of the noise suppression amount Rⱼ is less than the threshold value TH_Rs, the weighting coefficient calculation unit 12b outputs a predetermined value A2 (referred to also as a “second value”) as the weighting coefficient αⱼ in step ST46. Here, the value A1 and the value A2 are constants greater than or equal to 0 and less than or equal to 1 and satisfying A1>A2. Incidentally, the value A1 and the value A2 are preliminarily set together with the threshold value TH_Rs. For example, TH_Rs=10, A1=0.5, and A2=0.2.

By calculating the weighting coefficient αⱼ as above, when the noise suppression amount Rⱼ is large in regard to a short section Dⱼ in which the data therein is judged to include speech, the post-noise suppression data Ss(t) has a possibility that speech has disappeared, and thus the ill effects of the noise suppression such as the disappearance of speech can be reduced by increasing the value of the weighting coefficient αⱼ for the input data Si(t). In contrast, when the noise suppression amount Rⱼ is small, ill effects of the disappearance of speech are considered to be slight, and thus the ill effects of the distortion or the disappearance of speech can be inhibited without greatly reducing the effect of the noise suppression by decreasing the weighting coefficient α for the input data Si(t) and relatively increasing the weighting on the post-noise suppression data Ss(t).

Next, the operation when the judgment result regarding the short section Dⱼ in the step ST43 is noise will be described below. In this case, the weighting coefficient calculation unit 12b in step ST47 judges whether or not the noise suppression amount Rⱼ is less than a predetermined threshold value TH_Rn (referred to also as a “second threshold value”), and if the noise suppression amount Rⱼ is less than the predetermined threshold value TH_Rn, sets a predetermined value A3 (referred to also as a “third value”) as the weighting coefficient αⱼ in step ST48. In contrast, if the noise suppression amount Rⱼ is greater than or equal to the threshold value TH_Rn, the weighting coefficient calculation unit 12b sets a predetermined value A4 (referred to also as a “fourth value”) as the weighting coefficient αⱼ in step ST49. Here, the value A3 and the value A4 are constants greater than or equal to 0 and less than or equal to 1 and satisfying A3≥A4. Incidentally, the value A3 and the value A4 are preliminarily set together with the threshold value TH_Rn as mentioned above. For example, TH_Rn=3, A3=0.5, and A4=0.2.

By calculating the weighting coefficient α as above, in regard to data judged as noise, in a noise environment in which it can be considered that the effect of the noise suppression is slight due to a small noise suppression amount Rⱼ and ill effects of the distortion or the disappearance of speech can increase adversely, the ill effects of the noise suppression can be reduced by increasing the weighting coefficient α for the input data Si(t). In contrast, when the noise suppression amount Rⱼ is large, the effect of the noise suppression is considered to be great, and thus the ill effects of the distortion or the disappearance of speech can be inhibited without greatly reducing the effect of the noise suppression by decreasing the weighting coefficient α for the input data Si(t) and relatively increasing the weighting on the post-noise suppression data Ss(t).

Subsequently, the weighting coefficient calculation unit 12b in step ST50 checks whether or not the weighting coefficient αⱼ has been calculated for all the short sections Dⱼ (j=1, 2, . . . , J). If the weighting coefficient αⱼ has been calculated for all the short sections, the process is ended. In contrast, if there exists a short section Dⱼ for which the weighting coefficient αⱼ has not been calculated yet, the value of j is incremented by 1 in step ST51 and the process returns to the step ST41. The above is an example of the method of calculating the weighting coefficients αⱼ (j=1, 2, . . . , J).

As described above, with the noise suppression device 3 or the noise suppression method according to the third embodiment, in regard to data judged by use of the speech noise judgment model 16 to include speech, when the noise suppression amount Rⱼ is large, the post-noise suppression data Ss(t) has a possibility that speech has disappeared, and thus the ill effects of the noise suppression such as the disappearance of speech can be reduced by increasing the value of the weighting coefficient αⱼ for the input data Si(t).

In contrast, when the noise suppression amount Rⱼ is small, ill effects of the disappearance of speech are considered to be slight, and thus the ill effects of the distortion or the disappearance of speech can be inhibited without greatly reducing the effect of the noise suppression by decreasing the weighting coefficient α for the input data Si(t) and relatively increasing the weighting on the post-noise suppression data Ss(t).

On the other hand, in regard to data judged by use of the speech noise judgment model 16 as noise, in a noise environment in which it can be considered that the effect of the noise suppression is slight due to a small noise suppression amount Rⱼ and ill effects of the distortion or the disappearance of speech can increase adversely, the ill effects of the noise suppression can be reduced by increasing the weighting coefficient α for the input data Si(t).

In contrast, when the noise suppression amount Rⱼ is large, the effect of the noise suppression is considered to be great, and thus the ill effects of the distortion or the disappearance of speech can be inhibited without greatly reducing the effect of the noise suppression by decreasing the weighting coefficient α for the input data Si(t) and relatively increasing the weighting on the post-noise suppression data Ss(t).

Incidentally, except for the above-described features, the third embodiment is the same as the first embodiment.

### Modification

A speech recognition device can be formed by connecting a publicly known speech recognition engine that converts speech data to text data after any one of the above-described noise suppression devices 1 to 3, by which speech recognition accuracy in speech recognition devices can be increased. For example, when the user situated outdoors or in a factory inputs a result of inspection of equipment by means of speech by using the speech recognition device, the speech recognition can be executed with high speech recognition accuracy even when there is noise such as operation sound of the equipment.

### DESCRIPTION OF REFERENCE CHARACTERS

1-3: noise suppression device, 11: noise suppression unit, 12, 12a, 12b: weighting coefficient calculation unit, 13, 13b: weighted sum unit, 14: weighting coefficient table, 15: noise type judgment model, 16: speech noise judgment model, 101: processor, 102: memory, 103: nonvolatile storage device, 104: input-output interface, Si(t): input data, Ss(t): post-noise suppression data, So(t): output data, Dⱼ: short section, α, α₁: weighting coefficient, R, Rⱼ: noise suppression amount.

What is claimed is:

1. A noise suppression device comprising:
processing circuitry
to generate post-noise suppression data by performing a noise suppression process on input data;
to determine a weighting coefficient based on the input data in a predetermined section in a time series and the post-noise suppression data in the predetermined section; and
to generate output data by performing weighted addition on the input data and the post-noise suppression data by using values based on the weighting coefficient as weights.

2. The noise suppression device according to claim 1, wherein the processing circuitry uses a period from a time point when inputting the input data is started till elapse of a predetermined time as the predetermined section.

3. The noise suppression device according to claim 1, wherein the processing circuitry calculates the weighting coefficient based on a ratio between power of the input data in the predetermined section and power of the post-noise suppression data in the predetermined section.

4. The noise suppression device according to claim 1, further comprising:
a weighting coefficient table to hold predetermined candidates for the weighting coefficient while associating the predetermined candidates with noise identification numbers assigned respectively to a plurality of types of noise; and
a noise type judgment model used for judging which of the plurality of types of noise in the weighting coefficient table corresponds to a noise component included in the input data based on a spectral feature value of the input data, wherein
the processing circuitry
calculates noise, as one of the plurality of types of noise, being most similar to the data in the predetermined section in the input data by using the noise type judgment model, and
outputs a candidate for the weighting coefficient associated with the noise identification number of the calculated noise from the weighting coefficient table as the weighting coefficient.

5. A noise suppression device comprising:
processing circuitry
to generate post-noise suppression data by performing a noise suppression process on input data;
to segment data in a whole section of the input data into a plurality of predetermined short sections in a time series and to determine a weighting coefficient in each of the plurality of short sections based on the input data in the plurality of short sections and the post-noise suppression data in the plurality of short sections; and
to generate output data by performing weighted addition on the input data and the post-noise suppression data by using values based on the weighting coefficient as weights in each of the plurality of short sections.

6. The noise suppression device according to claim 5, further comprising a speech noise judgment model for judging whether the input data is speech or noise based on a spectral feature value of the input data, wherein
the processing circuitry
segments the data in the whole section of the input data into short sections in units of predetermined times,
calculates a noise suppression amount as a power ratio between the input data and the post-noise suppression data and judges whether the input data is speech or noise by using the speech noise judgment model in regard to each of the short sections,
sets the weighting coefficient at a predetermined first value if the noise suppression amount is greater than or equal to a predetermined first threshold value or sets the weighting coefficient at a predetermined second value less than the first value if the noise suppression amount is less than the first threshold value when the input data is judged as speech,
sets the weighting coefficient at a predetermined third value if the noise suppression amount is less than a predetermined second threshold value or sets the weighting coefficient at a predetermined fourth value greater than or equal to the third value if the noise suppression amount is greater than or equal to the second threshold value when the input data is judged as noise, and
outputs the weighting coefficient in regard to each of the short sections.

7. A noise suppression method executed by a computer, comprising:
generating post-noise suppression data by performing a noise suppression process on input data;
determining a weighting coefficient based on the input data in a predetermined section in a time series and the post-noise suppression data in the predetermined section; and
generating output data by performing weighted addition on the input data and the post-noise suppression data by using values based on the weighting coefficient as weights.

8. A non-transitory computer-readable storage medium storing a noise suppression program noise suppression program that causes a computer to execute the noise suppression method according to claim 7.

9. A noise suppression method executed by a computer, comprising:
generating post-noise suppression data by performing a noise suppression process on input data;
segmenting data in a whole section of the input data into a plurality of predetermined short sections in a time series and determining a weighting coefficient in each of the plurality of short sections based on the input data in the plurality of short sections and the post-noise suppression data in the plurality of short sections; and
generating output data by performing weighted addition on the input data and the post-noise suppression data by using values based on the weighting coefficient as weights in each of the plurality of short sections.

10. A non-transitory computer-readable storage medium storing a noise suppression program that causes a computer to execute the noise suppression method according to claim 9.
